(19) United States
(12) Patent Application Publication
(10) Pub. No.: US 2015/0138541 A1
(43) Pub. Date: May 21, 2015

(54) OBJECTIVE LENS SWITCHING MECHANISM AND INSPECTION APPARATUS

(71) Applicant: NUFLARE TECHNOLOGY, INC., Yokohama (JP)

(72) Inventors: Hideki NUKADA, Kanagawa (JP); Makoto TAYA, Tokyo (JP); Masaki SHIMIZU, Tokyo (JP); Takamasa FUKUDA, Kanagawa (JP); Riki OGAWA, Kanagawa (JP)

(21) Appl. No.: 14/542,273

(22) Filed: Nov. 14, 2014

(30) Foreign Application Priority Data
Nov. 19, 2013 (JP) 2013-239090

(51) Int. Cl. G02B 7/16; G01N 21/95; G02B 7/02; G01N 21/88

(52) U.S. Cl. CPC G02B 7/16; G01N 21/8806; G01N 21/95; G02B 7/021; G01N 2201/06113
USPC 356/237.5; 359/813

(57) ABSTRACT

An objective lens switching mechanism holds a plurality of objective lenses respectively disposed on each of the plurality of lens mounts, moves the plurality of objective lenses between a first position on the lens mounts and a second position above the lens mounts by a rotating mechanism and moves the plurality of objective lenses from the second position above the lens mounts to another second position above the lens mounts.

### CROSS-REFERENCE TO THE RELATED APPLICATION

The entire disclosure of the Japanese Patent Application No. 2013-239090, filed on Nov. 19, 2013 including specification, claims, drawings, and summary, on which the convention priority of the present application is based, are incorporated herein in their entirety.

### FIELD OF THE INVENTION

The present invention relates to an Objective Lens Switching Mechanism and Inspection Apparatus.

With high integration and large capacity of a Large Scale Integration (LSI), a circuit dimension required for a semiconductor element becomes increasingly narrowed. For example, a pattern having a line width of several tens of nanometers is required to be formed in the latest typical logic device.

It is necessary to improve a production yield of the expensive LSI in a production process. In the semiconductor element, during a production process, an original graphic pattern (that is, a mask or a reticle, hereinafter collectively referred to as a mask) in which a circuit pattern is formed is exposed and transferred onto a wafer by a reduction projection exposure apparatus called a stepper or a scanner. A shape defect of a mask pattern and fluctuations of various process conditions while the pattern is exposed and transferred can be cited as a large factor that reduces a production yield of the semiconductor element.

The finer the dimensions of an LSI pattern formed on the wafer becomes, the finer the shape defect of the mask pattern becomes. As enhancing dimensional accuracy of the mask absorbs fluctuations of various process conditions, it is necessary to detect the extremely small defect of patterns in a mask inspection. Therefore, high inspection accuracy and high inspection efficiency are required for an apparatus that inspects the pattern of a transfer mask used in the LSI production.

In the inspection apparatus, light emitted from the light source is irradiated onto the mask, which is an inspection target through an illumination optical system. The mask is placed on the table, and the emitted light scans the mask while the table moves. Generally, light transmitted through or reflected by the mask is formed as an optical image on an image sensor that is a light receiving device through an objective lens mounted on the inspection apparatus. Then, the optical image is captured by the image sensor, and sent to a comparator as measurement data. The comparator compares the measurement data and reference data acting on an appropriate algorithm. Then, in a case where the data does not match with each other, it is determined that there is a defect (see, for example, JP 2008-112178 A and JP 2007-248086 A).

In the above-described inspection apparatus, another objective lens of a more preferable optical quality may need to be selected according to the pattern formed on the mask or types of masks and be used for inspection. That is, it may be necessary to switch the originally mounted objective lens to another objective lens of a different optical quality to detect the defect of the pattern. For example, a plurality of objective lenses having different numerical apertures (NAs) may be prepared, and a more preferable objective lens may be selected according to the pattern of the mask or the type of the mask, and the mask inspection may be performed.

As described above, the conventional inspection apparatus is usually equipped with a single objective lens used for inspection. Therefore, when the objective lens is switched to another objective lens of different optical quality and used, it is necessary to perform an operation of removing the objective lens from the inspection apparatus and an operation of mounting a new objective lens. Hence, in the conventional inspection apparatus, the switching of the objective lens is an operation that is accompanied by complexity and is a factor that lowers the inspection efficiency.

The objective lens also needs to be installed with high position accuracy so as to achieve high inspection accuracy. For example, the objective lens maybe disposed on a dedicated lens mount and be disposed at an inspection position for performing the inspection. In this case, the objective lens needs to be disposed in close contact with a mount surface of a lens mount with high horizontal installation accuracy. It is necessary to maintain the high position accuracy of the objective lens even after the operation of switching the objective lens.

From the above, in the inspection apparatus for inspecting the mask or the like, there is a need for an objective lens switching mechanism that can easily select another objective lens, switch the objective lens to the selected objective lens and arrange the selected objective lens with high accuracy. In the inspection apparatus, there is a need to achieve high inspection efficiency.

The present invention has been made in view of the above problem. That is, an object of the present invention is to provide an objective lens switching mechanism that can easily switch an objective lens to another objective lens and arrange the another objective lens with high accuracy.

Another object of the present invention is to provide an inspection apparatus that can easily switch an objective lens to another objective lens and achieve high inspection efficiency.

Other challenges and advantages of the present invention are apparent from the following description.

### SUMMARY OF THE INVENTION

According to one aspect of the present invention, an objective lens switching mechanism comprising: a rotating mechanism configured to include a rotating table and a stage disposed on the rotating table;

a plurality of lens mounts disposed around the rotating mechanism;

a plurality of objective lenses respectively disposed on each of the plurality of lens mounts;

a lens holder disposed on the stage of the rotating mechanism and configured to hold each of the plurality of objective lenses; and a plurality of connecting members, which is attached to the lens holder, configured to respectively connect each of the plurality of objective lenses to the lens holder, wherein the objective lenses are moved between a first position on the lens mounts and a second position above the lens mounts by an operation of the stage of the rotating mechanism and are moved from the the second position above the lens mounts to another second position above the lens mounts by an operation of the rotating table, so that one selected from the plurality of objective lenses is disposed on the lens mount of a desired position.

Further to this aspect of the present invention, the first position is an installation position on the lens mount of the objective lens, and the second position is a position above the lens mount to an upper side in a vertical direction.

Further to this aspect of the present invention, the lens holder includes a support member configured to contact a portion of the objective lens and support the objective lens from a lower side, and the support member is configured to contact and support the objective lens when the lens holder is moved by the operation of the stage and the objective lens is moved from the first position to the second position.

Further to this aspect of the present invention, the lens holder includes a support member configured to contact a portion of the objective lens and support the objective lens from a lower side, and the support member is configured to contact and support the objective lens when the lens holder is moved by the operation of the stage and the objective lens is moved from the first position to the second position.

Further to this aspect of the present invention, the connecting member is a spring member that has a flexibility in a direction parallel to an operating direction of the stage and has a stiffness in a direction perpendicular to the operating direction of the stage.

Further to this aspect of the present invention, the connecting member is a spring member that has a flexibility in a direction parallel to an operating direction of the stage and has a stiffness in a direction perpendicular to the operating direction of the stage.

Further to this aspect of the present invention, the connecting member is a spring member that has a flexibility in a direction parallel to an operating direction of the stage and has a stiffness in a direction perpendicular to the operating direction of the stage.

Further to this aspect of the present invention, the connecting member is a spring member that has a flexibility in a direction parallel to an operating direction of the stage and has a stiffness in a direction perpendicular to the operating direction of the stage.

Further to this aspect of the present invention, the first aspect of the present invention, it is desirable that the objective lens selected from the plurality of objective lenses is disposed on the lens mount of the desired position which is an inspection position of an inspection apparatus for optically inspecting a sample to be inspected when the objective lens switching mechanism is used as a component of the inspection apparatus.

In another aspect of the present invention, an inspection apparatus comprising:
a light receiving device configured to capture an optical image of a sample to be inspected;
an illumination optical system configured to irradiate the sample with inspection light; and
an objective lens switching mechanism configured to include a plurality of objective lenses, select one of the objective lenses, dispose the selected objective lens at an inspection position, so as to form an image by the light passed through or reflected by the sample on the light receiving device,
wherein the objective lens switching mechanism includes:
a rotating mechanism configured to include a rotating table and a stage disposed on the rotating table;
a plurality of lens mounts disposed around the rotating mechanism;
a plurality of objective lenses respectively disposed on each of the plurality of lens mounts;
a lens holder disposed on the stage of the rotating mechanism and configured to hold each of the plurality of objective lenses; and
a plurality of connecting members, which is attached to the lens holder, configured to respectively connect each of the plurality of objective lenses to the lens holder,
wherein the objective lenses are moved between a first position on the lens mounts and a second position above the lens mounts by an operation of the stage of the rotating mechanism and are moved from the the second position above the lens mounts to another second position above another lens mounts by an operation of the rotating table, so that one selected from the plurality of objective lenses is disposed on the lens mount of a desired position which is the inspection position.

Further to this aspect of the present invention, the connecting member of the objective lens switching mechanism is a spring member that has a flexibility in a direction parallel to an operating direction of the stage and has a stiffness in a direction perpendicular to the operating direction of the stage.

### BRIEF DESCRIPTION OF THE DRAWINGS

FIG. 1 is a side view schematically describing a configuration of an objective lens switching mechanism according to a first embodiment of the present invention.

FIG. 2 is a schematic cross-sectional view illustrating a connecting portion between the objective lenses and a holding arm in the objective lens switching mechanism according to the first embodiment of the present invention.

FIG. 3 is a plan view illustrating a diaphragm used in a connecting member of the objective lens switching mechanism according to the first embodiment of the present invention.

FIG. 4 is a schematic cross-sectional view describing the operation of the connecting member in the objective lens switching mechanism according to the first embodiment of the present invention.

FIG. 5 is a schematic cross-sectional view illustrating a method for installing the connecting member in the objective lens switching mechanism according to the first embodiment of the present invention.

FIG. 6 is a schematic cross-sectional view illustrating a method for moving the objective lens in the Z-axis direction in the obj ective lens switching mechanism according to the first embodiment of the present invention.

FIG. 7 is a schematic configuration diagram of an inspection apparatus according to the second embodiment.

FIG. 8 is a view illustrating a data flow in the second embodiment of the present invention.

FIG. 9 is a flowchart illustrating the inspection method adopted on the inspection apparatus according to the second embodiment.

FIG. 10 shows the filtering step in the flowchart shown in FIG. 9.

### DETAILED DESCRIPTION OF THE EMBODIMENTS

### Embodiment 1

Hereinafter, an objective lens switching mechanism according to a first embodiment of the present invention will be described with appropriately reference to the drawings.

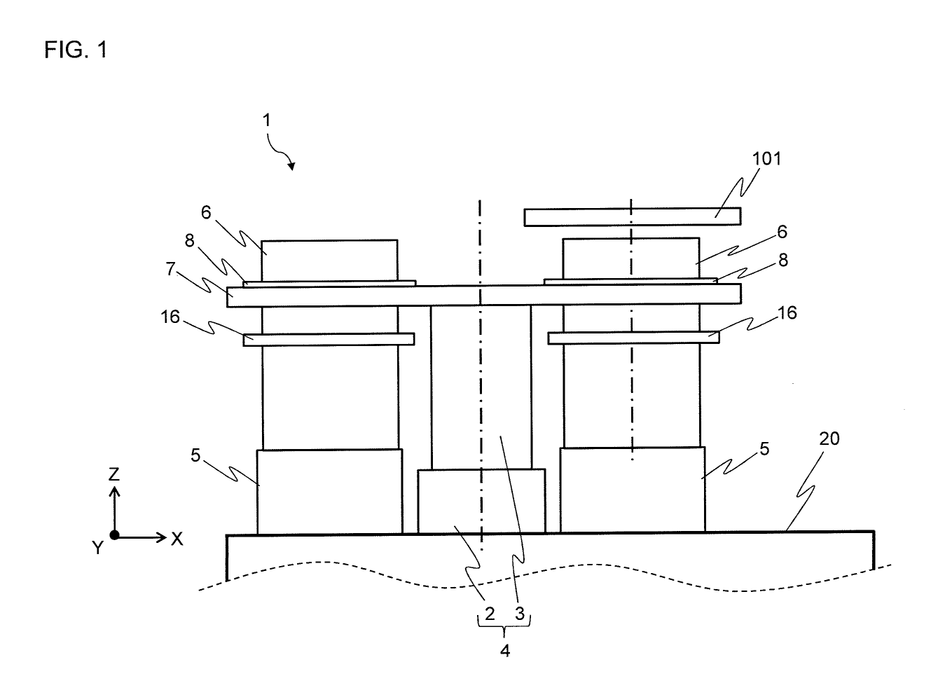

FIG. 1 is a side view schematically describing a configuration of an objective lens switching mechanism according to a first embodiment of the present invention.

As illustrated in FIG. 1, the objective lens switching mechanism 1 according to the first embodiment of the present invention includes a rotating base 4 provided on a base 20 as a rotating mechanism. The rotating base 4 includes a rotating table 2, and a Z-axis stage 3 disposed on the rotating table 2 as an example of a stage. The objective lens switching mechanism 1 includes two lens mounts 5 provided on the base 20 and disposed around the rotating base 4, and two objective lenses 6 disposed respectively on the lens mounts 5. Also, the objective lens switching mechanism 1 includes a holding arm 7 provided on the Z-axis stage 3 of the rotating base 4 as a lens holder. The holding arm 7 can serve as the lens holder to hold the two objective lenses 6. Furthermore, the objective lens switching mechanism 1 includes two connecting members 8 attached to the holding arm 7. The two connecting members 8 connect the two objective lenses 6 to the holding arm 7, respectively.

In the objective lens switching mechanism 1 according to the first embodiment of the present invention, the two objective lenses 6 are configured to move between first positions, which are installation positions of the two objective lenses 6 on the lens mounts 5, and second positions above the lens mounts above the lens mounts 5 to upper sides of a Z-axis direction (vertical direction) by the operation of the Z-axis stage 3 of the rotating base 4 serving as the rotating mechanism. In the objective lens switching mechanism 1, the two objective lenses 6 are configured to move between the second positions, which are above the lens mounts 5, that is, from one second positions to another second positions, which are spaced apart from the lens mounts 5 to upper sides of the Z-axis direction by the operation of the rotating table 2.

The objective lens switching mechanism 1 according to the first embodiment of the present invention, for example, can be used in a configuration of an inspection apparatus to be described below and can be used for an inspection of a mask 101 that is an example of a sample to be inspected.

In the following paragraphs, the respective elements of the objective lens switching mechanism 1 according to the first embodiment of the present invention will be described in detail.

In the objective lens switching mechanism 1, the rotating table 2 is configured to be rotatable within an XY plane perpendicular to a Z-axis direction. The rotating table 2 can rotate the Z-axis stage 3 disposed thereon as an example of a stage within the XY plane.

The Z-axis stage 3 is configured to be operable along the Z-axis direction, that is, the vertical direction of the drawing. Therefore, the Z-axis stage 3 can lift the holding arm 7 attached thereto up along the Z-axis direction, that is, the vertical direction of the drawing. Furthermore, the Z-axis stage 3 can lower the lifted holding arm 7.

Each of the plurality of lens mounts 5 disposed around the rotating base 4 corresponds to a shape of the objective lens 6 usually having a column shape. For example, each of the plurality of lens mounts 5 has a flat cylindrical shape with a larger diameter than the objective lens 6. A top surface of the lens mount 5 serves as a mount surface on which the objective lens 6 can be disposed. At this time, the objective lens 6 is preferably disposed such that an optical axis of the objective lens 6 is parallel to the Z-axis direction. The objective lens 6 is installed on the lens mount 5 and disposed at the first position described above.

Also, in the objective lens switching mechanism 1 illustrated in FIG. 1, the two lens mounts 5 are provided to face each other, with the rotating base 4 interposed therebetween, and the two objective lenses 6 are disposed thereon. In the objective lens switching mechanism 1, the two objective lenses 6 face each other with the rotating base 4 interposed therebetween, and are provided in a linear arrangement. However, in the objective lens switching mechanism 1 according to the first embodiment of the present invention, the number of the lens mounts 5 and the number of the objective lenses 6 are not limited to two, respectively, but can be three or more, for example, three or four, respectively.

The objective lenses 6 are preferably disposed to be fixed on the lens mounts 5, for example, by using an adsorption mechanism employing a vacuum chuck mechanism or via a magnetic method. The objective lenses 6 are preferably disposed in close contact with the lens mounts 5 on a bottom surface side thereof so as to be disposed with high accuracy. At this time, the horizontal installation accuracy of the objective lens 6 is preferably ±2 μm or less.

In the objective lens switching mechanism 1, the holding arm 7 is provided to similarly hold each of the two objective lenses 6 disposed to face each other, with the rotating base 4 interposed therebetween.

In the objective lens switching mechanism 1, both ends of the holding arm 7 have a rounded strip shape along the side surfaces of the objective lenses, such that the two column-shaped objective lenses 6 can be held at the tip portions of the holding arm 7.

Also, as described above, in the objective lens switching mechanism 1 according to the first embodiment of the present invention, the number of the lens mounts 5 and the number of the objective lenses 6 are not limited to two, respectively, but can be three or more, for example, three or four, respectively.

In that case, the holding arm 7 can have a preferable shape corresponding to the number of the objective lenses 6 to be hold. For example, in plan view, the holding arm 7 has a rounded Y or T shape in which each tip portion is rounded so as to hold three objective lenses 6, or a rounded cross shape in which each tip portion is rounded so as to hold four objective lenses 6. In that case, the connecting members to be described below are disposed at the tip portions of the holding arm 7 that hold the respective objective lenses 6.

As described above, the objective lens switching mechanism 1 includes two connecting members 8 attached to the holding arm 7 so as to connect the two objective lenses 6 to the holding arm 7, respectively.

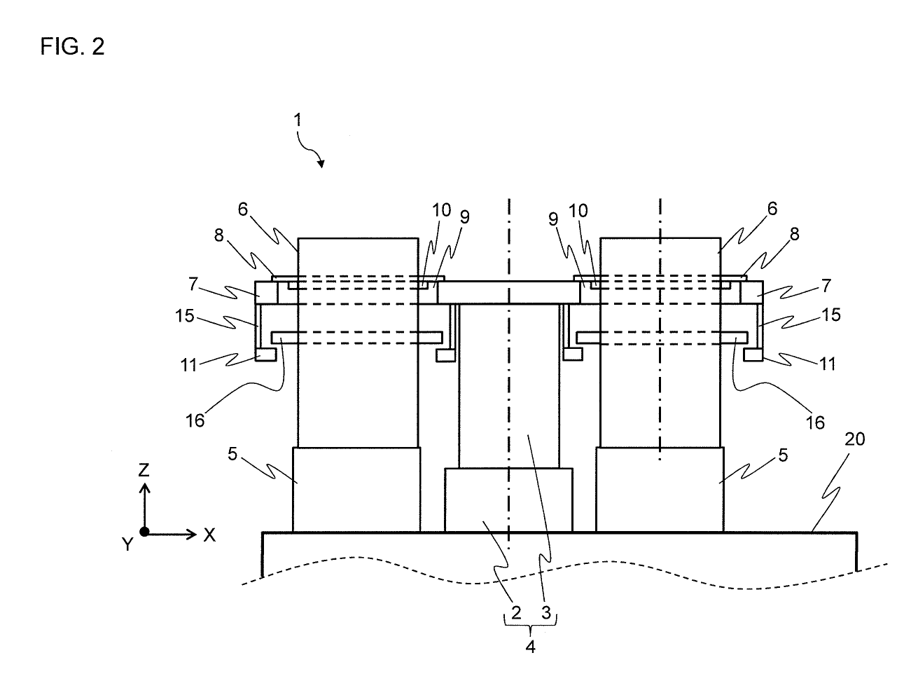

FIG. 2 is a schematic cross-sectional view illustrating a connecting portion between the objective lenses and the holding arm in the objective lens switching mechanism according to the first embodiment of the present invention.

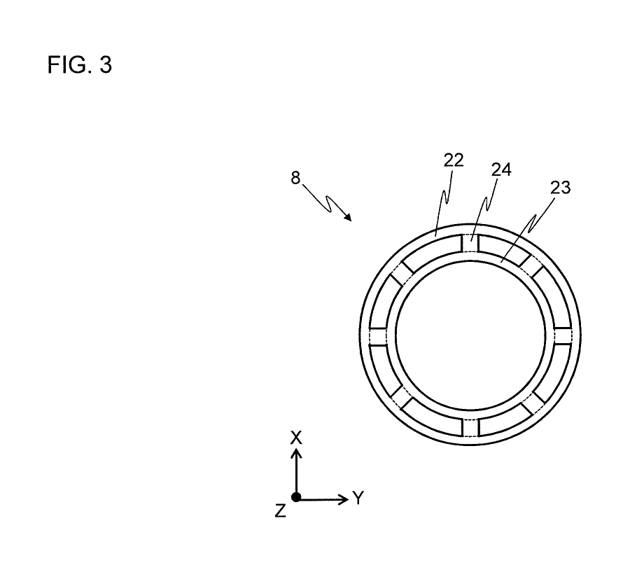

FIG. 3 is a plan view illustrating a diaphragm used in the connecting member of the objective lens switching mechanism according to the first embodiment of the present invention.

In the objective lens switching mechanism 1, as the connecting member 8, a spring member can be selected which has a flexibility in a direction parallel to the operating direction of the Z-axis stage 3 and has a stiffness in a direction perpendicular to the operating direction (Z direction) of the Z-axis stage 3, that is, a horizontal direction (XY direction) of the drawing.

In the objective lens switching mechanism 1 according to the first embodiment of the present invention, a preferred example of the connecting members 8 includes a diaphragm that has a flexibility in a direction parallel to the operating direction of the Z-axis stage 3 and has a stiffness in a direction perpendicular to the operating direction of the Z-axis stage 3.

As illustrated in FIG. 3, the diaphragm used as the connecting members 8 is a disk-shaped spring member having a ring shape with a central portion opened in a circular shape. The diaphragm includes two ring-shaped plate members 22 and 23 with different diameters. The small ring-shaped plate member 23 is housed within the ring of the large ring-shaped plate member 22, such that the ring-shaped plate members 22 and 23 are spaced apart from each other. The centers of the ring-shaped plate members 22 and 23 are matched with each other and are mutually connected by a plurality of beams 24. FIG. 3 shows dotted lines indicating hypothetical boundary lines between the two ring-shaped plate members 22 and 23, and the plurality of beams 24, these dotted lines are only for descriptive purposes, as these components are all integrated.

The connecting member 8 that is the diaphragm acts as a spring with respect to a member inserted into the opening of the center. That is, when a member inserted into the opening is moved vertically with respect to the installation plane of the connecting member 8, the connecting member 8 that is the diaphragm allows the movement of the member and applies force to return the member to the original position. On the other hand, when the member inserted into the opening is moved in a direction (XY direction) parallel to the installation plane of the connecting member 8, the connecting member 8 suppresses the movement of the member according to the stiffness of the member.

As illustrated in FIG. 2, the connecting member 8 is installed in a connecting portion between the holding arm 7 and the objective lens 6 and connects the holding arm 7 and the objective lens 6.

The example of the detailed connection configuration illustrated in FIG. 2 will next be described.

Openings 9 are provided in the tip portions of the holding arm 7. Each opening 9 of the holding arm 7 is configured to have a circular shape with a larger diameter than the objective lens 6 so as to correspond to the shape of the column-shaped objective lens 6 inserted thereinto.

The disk-shaped connecting member 8, the center of which is opened, is disposed on the tip portion of the holding arm 7 so as to cover the peripheral portion of the opening 9. At this time, the center of the opening 9 and the center of the opening of the connecting member 8 are preferably installed to match each other.

Therefore, the column-shaped objective lens 6 is inserted into the opening of the connecting member 8, then is inserted into the opening 9 of the holding arm 7, and then is disposed at the first position onto the lens mount 5. At this time, the diameter of the opening 9 of the holding arm 7 is set to be larger than the diameter of the circular cross-section of the column-shaped objective lens 6. In the connecting portion, the objective lens 6 is inserted with being spaced apart from the peripheral portion of the opening 9 of the holding arm 7. In the case where the objective lens 6 has a fitted connecting ring 10 as described below, the objective lens 6 is inserted into the opening 9 such that the outer peripheral surface of the connecting ring 10 is also spaced apart from the peripheral portion of the opening 9 of the holding arm 7.

On the other hand, the diameter of the circular opening of the connecting member 8 is set to be equal to or slightly smaller than the diameter of the cross-section of the objective lens 6. Therefore, in the connecting portion between the objective lens 6 and the holding arm 7, the objective lens 6 is inserted such that the objective lens 6 comes into contact with the peripheral portion of the opening of the connecting member 8 in the outer peripheral surface of the objective lens 6.

The objective lens 6 includes the connecting ring 10. The connecting ring 10 is fitted into the objective lens 6 and is fixed on the outer peripheral surface of the objective lens 6. In the column-shaped objective lens 6, a portion into which the connecting ring 10 is fitted is a portion in which the connecting ring 10 protrudes in a ring shape and the diameter thereof is set to be larger than the other portion. Therefore, as illustrated in the drawing, the connecting member 8 contacts the outer peripheral surface of the objective lens 6 and the top surface of the connecting ring 10 disposed on the outer peripheral surface thereof with respect to the objective lens 6 inserted into the opening of the connecting member 8.

In the case where the objective lens 6 is moved in the Z-axis direction that is the vertical direction with respect to the installation plane of the connecting member 8, the connecting member 8 allows the movement of the objective lens 6.

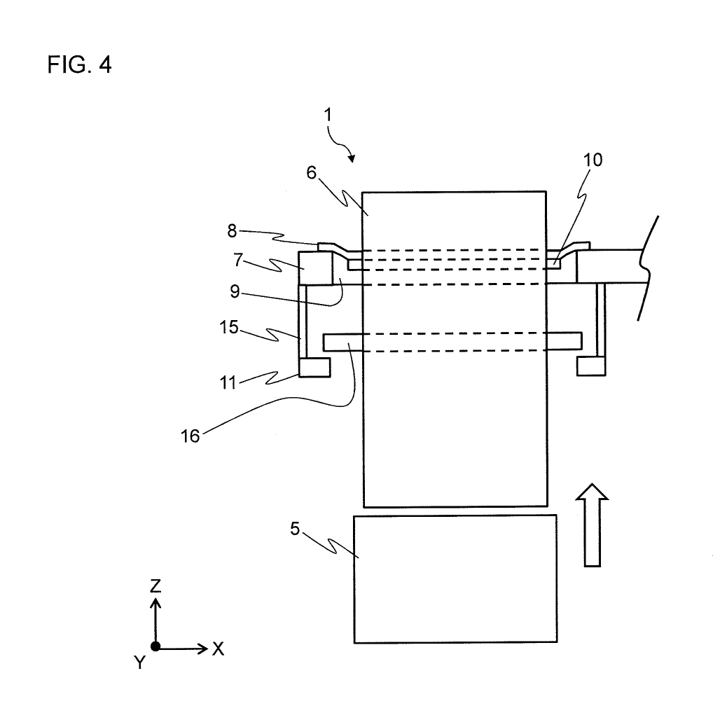

FIG. 4 is a schematic cross-sectional view describing the operation of the connecting member in the objective lens switching mechanism according to the first embodiment of the present invention.

In FIG. 4, one objective lens 6 is illustrated and the operation of the connecting member 8 is described.

As illustrated in FIG. 4, in the case where the objective lens 6 is moved in the Z-axis direction being the vertical direction with respect to the installation plane of the connecting member 8, the connecting member 8 is deformed to be bent in the Z-axis direction, thereby allowing the movement of the objective lens 6 . On the other hand, the connecting member 8 applies force to maintain a relative position in the Z-axis direction between the objective lens 6 and the connecting member 8 and thus a relative position in the Z-axis direction between the objective lens 6 and the holding arm 7 before such a movement of the objective lens 6 is occurs.

On the other hand, when the objective lens 6 is moved in a parallel direction from the original position with respect to the installation plane of the connecting member 8, the connecting member 8 suppresses the movement of the objective lens 6 according to the stiffness thereof. That is, the connecting member 8 disposed on the XY plane suppresses the XY-direction movement of the objective lens 6.

Therefore, in the case where the holding arm 7 is moved upward in the Z-axis direction by the operation of the Z-axis stage 3 and thus the objective lens 6 is moved from the first position onto the lens mount 5 to the second position above the lens mount 5, the relationship of the relative position in the XY direction between the objective lens 6 and the lens mount 5 at the first position is maintained by the connecting member 8. In that case, the displacement in the Z-axis direction between the objective lens 6 and the holding arm 7 in the Z-axis direction is allowed, but the force is applied by the connecting member 8 so as to restore the relationship of the relative position in the Z-axis direction between the objective lens 6 and the holding arm 7 to the relationship at the first position.

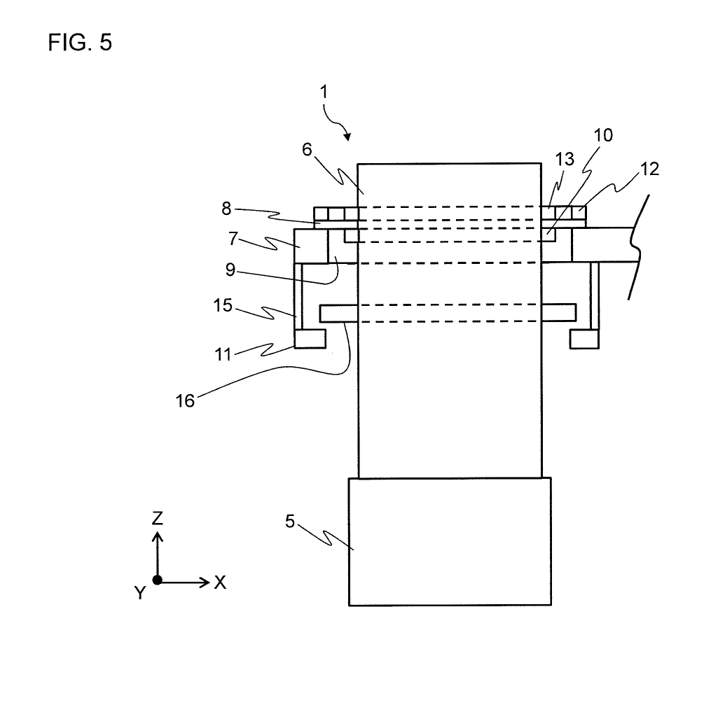

FIG. 5 is a schematic cross-sectional view illustrating a method for installing the connecting member in the objective lens switching mechanism according to the first embodiment of the present invention.

In FIG. 5, one objective lens 6 is illustrated and the method for installing the connecting member 8 is described.

As described above, the connecting member 8 is provided on the tip portion of the holding arm 7 to cover the peripheral portion of the opening 9 at the tip of the holding arm 7 and is fixed to the holding arm 7. Fixing the connecting member 8 to the holding arm 7 is performed using a holding-arm-side ring 12. The holding-arm-side ring 12 has a ring shape with an opened center and is provided to cover the peripheral portion of the opening 9 of the holding arm 7. The holding-arm-side ring 12 fixes the connecting member 8 to the holding arm 7, with the outer peripheral portion of the connecting member 8 interposed between the holding arm 7 and the ring 12.

Furthermore, as illustrated in FIG. 5, the objective lens switching mechanism 1 according to the first embodiment of the present invention can include a lens-side ring 13. The lens-side ring 13 has a ring shape with an opened center as in the connecting ring 10 of the objective lens 6 and is fitted onto the objective lens 6 and provided on the outer peripheral surface thereof as in the connecting ring 10 of the objective lens 6. The lens-side ring 13 fixes the peripheral portion of the opening of the connecting member 8 between the connecting ring 10 and the ring 13, with the peripheral portion of the opening of the connecting member 8 interposed between the connecting ring 10 and the ring 13. By providing the lens-side ring 13 as above, in the case where the objective lens 6 is displaced in the vertical direction with respect to the installation plane of the connecting member 8, the displacement is allowed and the tilt of the objective lens 6 or the like can be controlled with high accuracy. Force can be applied to the objective lens 6 such that the relative position relationship between the objective lens 6 and the holding arm 7 is returned to the state in which the objective lens 6 is disposed at the first position.

Also, as illustrated in FIGS. 2, 4, and 5, etc. the objective lens switching mechanism 1 according to the first embodiment of the present invention can include a support member 11 for supporting the objective lens 6.

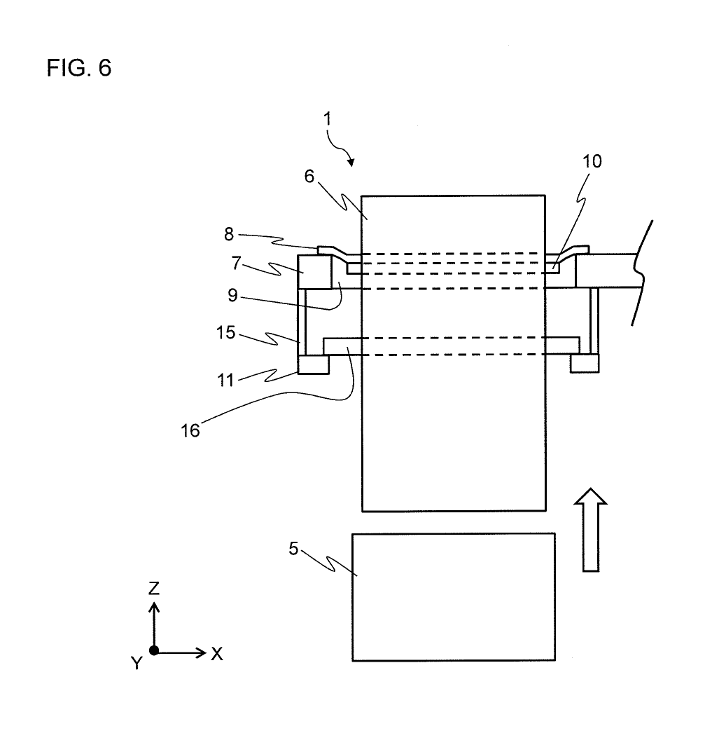

FIG. 6 is a schematic cross-sectional view illustrating a method for moving the objective lens in the Z-axis direction in the objective lens switching mechanism according to the first embodiment of the present invention.

In FIG. 6, as in FIG. 4, one objective lens 6 is illustrated and the method for moving the objective lens 6 is described.

In the case where the plurality of objective lenses 6 are moved between the first position onto the lens mount 5 and the second position above the lens mount 5 upward in the Z-axis direction by the operation of the Z-axis stage 3 of the rotating base 4, a stable movement can be achieved by the support member 11 included in the objective lens switching mechanism 1.

For example, as illustrated in FIG. 6, the support member 11 can be configured to have a disk shape with a central portion opened in a circular shape, such that the objective lens 6 is supported when the objective lens 6 is moved from the first position to the second position.

The ring-shaped support member 11 is held by a suspending member 15 vertically disposed around the opening 9 at the tip portion of the holding arm 7 and is disposed below the opening 9. At this time, the opening center of the support member 11 is preferably matched with the center of the opening of the connecting member 8 disposed on the holding arm 7. When the holding arm 7 is moved in a direction parallel to the Z-axis direction according to the operation of the Z-axis stage 3, the support member 11 follows the movement and moves in a direction parallel to the Z-axis direction.

The objective lens 6 can include a holding ring 16. The holding ring 16 is fitted onto the objective lens 6 and is fixed on the outer peripheral surface of the objective lens 6. In the column-shaped objective lens 6, a portion onto which the holding ring 16 is fitted is a portion on which the holding ring 16 protrudes in a ring shape and the diameter thereof is set to be larger than the other portion.

The objective lens 6 including the holding ring 16 is inserted into the opening of the support member 11 and is disposed at the first position onto the lens mount 5 in a state of being inserted into the opening of the connecting member 8 and the opening 9 of the holding arm 7. At this time, the objective lens switching mechanism 1 is configured such that the support member 11 is disposed below the holding ring 16 so as to be spaced apart from the holding ring 16 of the objective lens 6.

Therefore, as illustrated in FIG. 6, the support member 11 contacts the holding ring 16 from the lower side with respect to the objective lens 6 inserted into the opening of the connecting member 8 by the lifting of the holding arm 7 due to the operation of the Z-axis stage 3. Furthermore, when the holding arm 7 is lifted by the Z-axis stage 3, the objective lens 6 is transferred from the lens mount 5 to the support member 11. The support member 11 supports the objective lens 6 from the lower side through the holding ring 16. The holding arm 7 can lift, by the support member 11, the objective lens 6 from the first position onto the lens mount 5 to the second position above the lens mount 5 in the Z-axis direction.

The second position is preferably located such that a spacing width between the bottom surface side of the objective lens 6 and the mount surface of the lens mount 5 is in the range of 50 μm to 200 μm.

In the objective lens switching mechanism 1 according to the first embodiment of the present invention, the connecting member 8 on the holding arm 7 acts as the above-described spring.

That is, in the objective lens 6 and the holding arm 7, when the objective lens 6 is at the second position, the relationship of the relative position in the XY direction when the objective lens 6 is at the first position is maintained by the connecting member 8. As a result, in the objective lens 6 and the lens mount 5, when the objective lens 6 is at the second position, the relationship of the relative position in the XY direction when the objective lens 6 is at the first position is maintained by the connecting member 8.

On the other hand, in the objective lens 6 and the holding arm 7, when the objective lens 6 is at the second position, an occurrence of a slight change in the relationship of the relative position in the Z-axis direction is allowed by reference to the relationship of the relative position in the Z-axis direction. Force is applied by the connecting member 8 so as to restore the relative position relationship in the Z-axis direction between the objective lens 6 and the holding arm 7 to the relative position relationship in the Z-axis direction when the objective lens 6 is at the first position.

As described above, due to the operation of the Z-axis stage 3 of the rotating base 4, the objective lens switching mechanism 1 configured to include the above elements according to the first embodiment of the present invention can move the two objective lenses 6 between the first positions, which are the installation position onto the lens mounts 5, and the second positions above the lens mounts 5 upward in the Z-axis direction with supporting the two objective lenses 6 by the holding arm 7 and the support member 11.

Due to the operation of the rotating table 2, the objective lens switching mechanism 1 can move the two objective lenses 6 between the second positions above the lens mounts 5 and other second positions above the lens mounts 5 upward in the Z-axis direction with supporting the two objective lenses 6 by the holding arm 7 and the support member 11.

As a result, the objective lens switching mechanism 1 according to the first embodiment of the present invention can switch and dispose each of the two objective lenses 6 from the originally disposed lens mount 5 to another lens mount. That is, one of the two objective lenses 6 can be selected and then the selected objective lens can be disposed from the first position onto the original lens mount 5 to another lens mount 5 disposed at a desired position.

Specifically, the objective lens 6 disposed at the first position onto the lens mount 5 is delivered from the lens mount 5 to the support member 11 by the lifting operation of the Z-axis stage 3 of the rotating base 4. The holding arm 7 and the support member 11 support the objective lens 6 and lift the objective lens 6 to the upper side parallel to the Z-axis direction. As a result, the objective lens 6 is moved to the second position above the lens mount 5 at which the objective lens 6 is originally disposed.

In a state in which the objective lens 6 is supported by the holding arm 7 and the support member 11, the rotating operation of the rotating table 2 moves the objective lens 6 from the original second position to another second position above a desired lens mount 5 that is different from the above-described lens mount 5.

Due to the lowering operation of the Z-axis stage 3, the objective lens 6 disposed at the second position above the above-described desired lens mount 5 is then lowered toward the desired lens mount 5 while being supported by the holding arm 7 and the support member 11. The objective lens 6 is delivered to the desired lens mount 5 and is disposed onto the mount surface of the desired lens mount 5.

At this time, as described above, the objective lens 6 is connected to the holding arm 7 through the connecting member 8. The connecting member 8 is a spring member that has a flexibility in a direction parallel to the operating direction of the Z-axis stage 3 and has a stiffness in a direction perpendicular to the operating direction (Z direction) of the Z-axis stage 3, that is, a horizontal direction (XY direction) of the drawing.

Therefore, when the objective lens 6 inserted into the opening of the connecting member 8 is moved to a direction perpendicular to the installation plane of the connecting member 8, the connecting member 8 can allow the movement of the objective lens 6 and can also allow a slight tilt of the objective lens 6. And then, the connecting member 8 applies force to return the objective lens 6 to the original state. On the other hand, when the objective lens 6 inserted into the opening of the connecting member 8 is moved in a direction (XY direction) parallel to the installation plane of the connecting member 8, the connecting member 8 suppresses the movement of the objective lens 6 according to the stiffness thereof.

Therefore, if the high-accuracy position setting can be performed onto the lens mount 5 once, the objective lens 6 cause no deviation in the relative position with respect to the holding arm 7 even when the movement between the first position and the second position and the movement between the different second positions are repeated. As a result, even when the movement between the first position and the second position and the movement between the different second positions are repeated, the objective lens 6 can realize an arrangement without position deviation in the XY direction onto the lens mount 5.

Further, since the connecting member 8 allows the movement of the objective lens 6 in a direction perpendicular to the installation plane of the connecting member 8, a slight relative tilt between the objective lens 6 and the holding arm 7 is allowed in a state in which the objective lens 6 is not supported by the support member 11 of the holding arm 7. Therefore, the objective lens switching mechanism 1 can dispose the objective lens 6 onto the lens mount 5 by bringing the bottom surface side of the objective lens 6 into close contact with the mount surface of the lens mount 5, without being affected by the relative tilt between the mount surface of the lens mount 5 and the holding arm 7.

Furthermore, as described above, the objective lens switching mechanism 1 disposes the objective lens 6 onto the mount surface of the lens mount 5 by lowering the Z-axis stage 3 in a state of being supported by the holding arm 7 and the support member 11. In that case, due to the spring action of the connecting member 8, it is possible to offset the weight of the objective lens 6 at the moment when the objective lens 6 starts contacting the mount surface of the lens mount 5. Therefore, the objective lens switching mechanism 1 can absorb an impact force applied to the objective lens 6 at the time when the objective lens 6 is installed onto the lens mount 5 and can realize a stable installation without damage to the objective lens 6.

As mentioned above, the objective lens switching mechanism 1 according to the first embodiment of the present invention can maintain the relative position accuracy between the objective lens 6 and the holding arm 7 and can reliably dispose the objective lens 6 in close contact with the mount surface of the lens mount 5 with high position accuracy. Furthermore, the objective lens switching mechanism 1 can absorb the impact applied to the objective lens 6 when disposed onto the mount surface, and can realize a stable arrangement of the objective lens 6 on the lens mount 5.

Therefore, the objective lens switching mechanism 1 according to the first embodiment of the present invention can easily and safely switch the objective lens to another objective lens and can dispose the another objective lens with high accuracy.

For example, the objective lens switching mechanism 1 according to the first embodiment of the present invention can be used in the configuration of the inspection apparatus of the present invention. The inspection apparatus may perform inspection while switching the objective lens 6 to be used for inspection to another objective lens according to performance capability thereof. In that case, one objective lens 6 having a desired performance capability can be selected from the two objective lenses 6 included in the objective lens switching mechanism 1 and can be installed by moving from the originally disposed position onto a lens mount 5 to another position onto another lens mount 5 at an inspection position. As a result, the inspection apparatus of the present invention can perform inspection by easily and safely switching an objective lens 6 to be used for inspection to another objective lens of a desired performance capability with superior installation position accuracy.

### Embodiment 2

Hereinafter, an Inspection Apparatus according to a second embodiment of the present invention will be described with appropriately reference to the drawings.

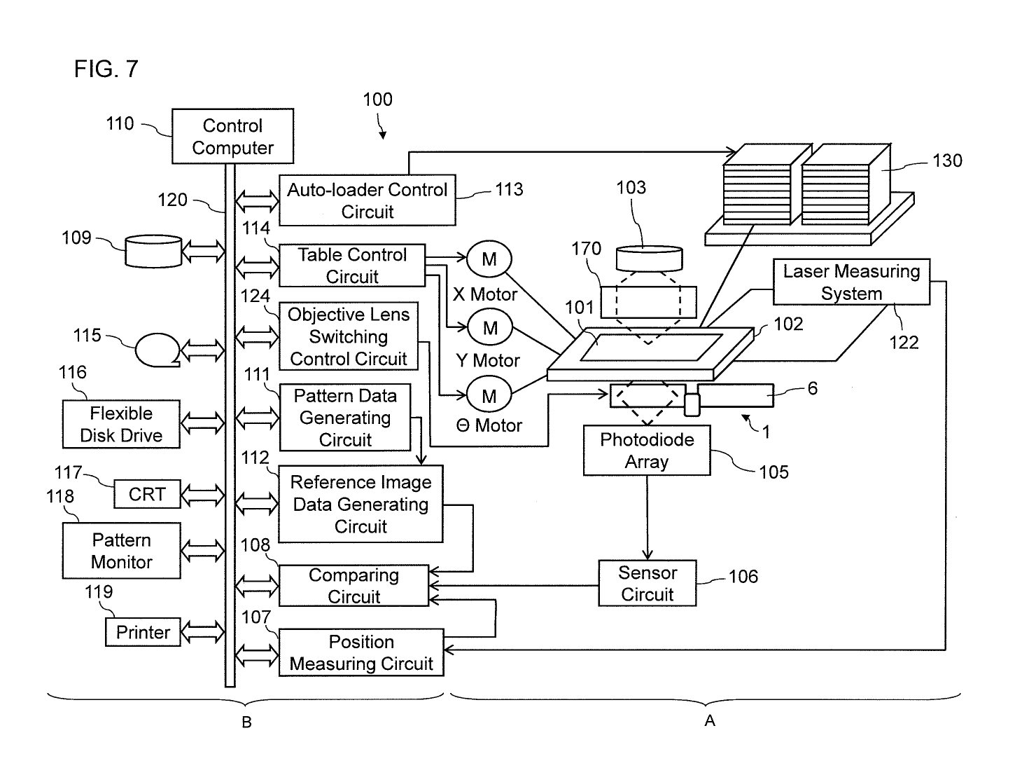

FIG. 7 is a schematic configuration diagram of an inspection apparatus according to the second embodiment.

In FIG. 7, a configuration necessary in the present embodiment is illustrated. However, another well-known configuration necessary for an inspection may be used. As used herein, a “circuit” can be configured by a program operating on a computer. Alternatively, the “circuit” may be constructed by not only the program that is software, but also a combination of software and hardware, or software and firmware. In the case that the “circuit” may be constructed by the program, the program can be stored in a storage such as a magnetic disk.

In the present embodiment, a mask used in photolithography, etc. is used as an inspection target. Alternatively, as another example, a wafer may be used as the inspection target.

As illustrated in FIG. 7, an inspection apparatus 100 includes a section A which acquires an optical image of a mask 101 as an example of the inspection target and a section B which performs a process necessary for the inspection using the optical image acquired in the section A. The above-described objective lens switching mechanism 1 according to the first embodiment of the present invention is included in the section A. Therefore, the inspection apparatus 100 according to the second embodiment of the present invention can easily switch an objective lens 6 to another objective lens 6 and realize the high inspection efficiency by using the objective lens switching mechanism 1 according to the first embodiment of the present invention.

The section A includes the light source 103 which emits an inspection light, an XYθ-table 102 which is an example of a table for mounting the inspection target mask 101 and that is movable in the horizontal directions (the X direction and the Y direction) and the rotation direction (the θ direction), an illumination optical system 170 which forms an transmitting illumination system to irradiate the mask 101 mounted on the XYθ-table 102 with the inspection light from the light source 103 in the normal direction (the vertical direction), an objective lens switching mechanism 1 including a plurality of objective lenses 6, a photodiode array 105 and a sensor circuit 106 which are an example of a light receiving device, and a laser measuring system 122.

The objective lens switching mechanism 1 of the section A is illustrated in FIG. 1, etc. and is, for example, the objective lens switching mechanism 1 including two objective lenses 6 according to the first embodiment of the present invention. The inspection apparatus 100 selects one objective lens 6 having performance capabilities suitable for inspection among the plurality of objective lenses 6 included in the objective lens switching mechanism 1 according to the fineness, etc. of the pattern formed on the mask 101 to be inspected or according to the type of the mask 101 to be inspected. By using the objective lens switching mechanism 1, the switching of the objective lens 6 according to the selection can be safely performed with high installation position accuracy. As a result, the inspection apparatus 100 can install one objective lens 6 having performance capabilities optimal to the inspection of the mask 101 at the inspection position for inspection and perform the inspection of the mask 101.

The section B can also include an objective lens switching control circuit 124 controlling the objective lens switching mechanism 1 of the section A. In that case, the inspection apparatus 100 can drive the objective lens switching mechanism 1 of the section A by the objective lens switching control circuit 124 and automatically perform online switching to the above-described obj ective lens 6 having the desired performance capability.

In addition, the section A may include an auto-loader 130 as illustrated in FIG. 7. The section B can also include an auto-loader control circuit 113 in correspondence to the case where the section A includes the auto-loader 130.

In the section A, the optical image data of the mask 101 that is the inspection target is acquired. The optical image of the mask 101 is an image of the mask 101 in which a figure pattern is formed based on graphic data included in design pattern data of the mask 101. For example, the optical image data of the mask 101 is 8-bit data with no code, and expresses a gradation of brightness of each pixel.

In the inspection apparatus 100, the mask 101, which is the inspection target, is mounted on the XYθ-table 102 of the section A. The XYθ-table 102 is moved by an X motor and a Y motor in two horizontal directions, the X and Y directions, orthogonal to each other, and rotated about a vertical θ axis by a θ motor. The laser measuring system 122 measures positions of the XYθ-table 102 in the X direction and the Y direction.

Then, the pattern formed on the mask 101 is illuminated with the inspection light emitted from the light source 103, which is disposed above the XYθ-table 102. More specifically, a light flux emitted from the light source 103 is directed onto the mask 101 through the illumination optical system 170. Under the mask 101, the objective lens switching mechanism 1 including a plurality of objective lenses 6, the photodiode array 105, and the sensor circuit 106 are disposed. The light, which passes through the mask 101, transmits the desired lens 6 selected from a plurality of objective lenses 6 included in the objective lens switching mechanism 1 and forms an optical image on the photodiode array 105.

The photodiode array 105 performs photoelectric conversion of the pattern image of the mask 101 formed on the photodiode array 105 and generates analog signals, and the sensor circuit 106 performs A/D (analog-digital) conversion of the analog signals and generates digital signals. A plurality of sensor cells (not illustrated) is disposed in the photodiode array 105. A TDI (Time Delay Integration) sensor can be cited as an example of the sensor disposed on the photodiode array 105. In this case, the TDI sensor captures the image of the pattern in the mask 101 while the XYθ-table 102 moves continuously. Further, there is a concern that the photodiode array 105 becomes heated as a result of use, therefore a water cooler is desirably provided for cooling purposes.

In the section A, the light source 103, the illumination optical system 170, an objective lens 6 installed above the photodiode array 105 by the objective lens switching mechanism 1, the photodiode array 105, and the sensor circuit 106 may constitute a high-magnification inspection optical system.

Next, the section B that performs processing necessary for the inspection using the optical image data acquired by the section A in the inspection apparatus 100 will be described below.

As shown in FIG. 7, in the section B, the control computer 110, that is, the controller controlling the whole of the inspection apparatus 100 is connected to an objective lens switching control circuit 124 that performs switching of the objective lens 6 included in the objective lens switching mechanism 1 of the section A, a position measuring circuit 107, a comparing circuit 108, a reference image data generating circuit 112, an pattern data generating circuit 111, an auto-loader control circuit 113, a table control circuit 114, a magnetic disk 109 that is an example of the storage device, a magnetic tape device 115, a flexible disk drive 116, a CRT (Cathode Ray Tube) 117, a pattern monitor 118, and a printer 119 through a bus 120 that constitutes a data transmission line.

As described above, the “circuit” in FIG. 7 can be configured as a program operating on the computer. Alternatively, the “circuit” may be constructed by not only the program, that is software, but also a combination of software and hardware, or software and firmware. In the case that the “circuit” may be constructed by the program, the program can be recorded in the magnetic disk 109. For example, each of the objective lens switching control circuit 124, the auto-loader control circuit 113, the table control circuit 114, the comparing circuit 108, and the position measuring circuit 107 may be constructed by an electric circuit, software that can be processed by the control computer 110, or the combination of the electric circuit and the software.

The control computer 110 controls the objective lens switching control circuit 124 such that the switching of the objective lens is performed among the plurality of objective lenses 6 so that the objective lens 6 to be used for inspection has the desired performance capability in the objective lens switching mechanism 1 of the section A.

The control computer 110 controls the table control circuit 114 to drive the XYθ-table 102. A displacement of the XYθ-table 102 is measured by the laser measuring system 122, and data of the measuring result is transmitted to the position measuring circuit 107.

The design pattern data that becomes reference data of the die-to-database method is stored in the magnetic disk 109. In the progress of the inspection, the design pattern data is retrieved and transmitted to the pattern data generating circuit 111. In the pattern data generating circuit 111, the design pattern data is converted into image data (design image data). After that, the image data is sent to the reference image data generating circuit 112 to generate a reference image data.

In the comparing circuit 108, the optical image data that is sent from the sensor circuit 106, and the reference image data which is generated in the reference image data generating circuit 112, are compared to each other using a proper comparison determination algorithm. As a result of the comparison, in the case that a difference between the two image data exceeds a predetermined threshold at a portion, the portion is determined to be a defect.

Further, the inspection apparatus 100 according to the present embodiment may include other well-known elements, which are necessary for inspecting the mask 101 in addition to the components illustrated in FIG. 7. For example, the inspection apparatus itself may include a review tool to be described below.

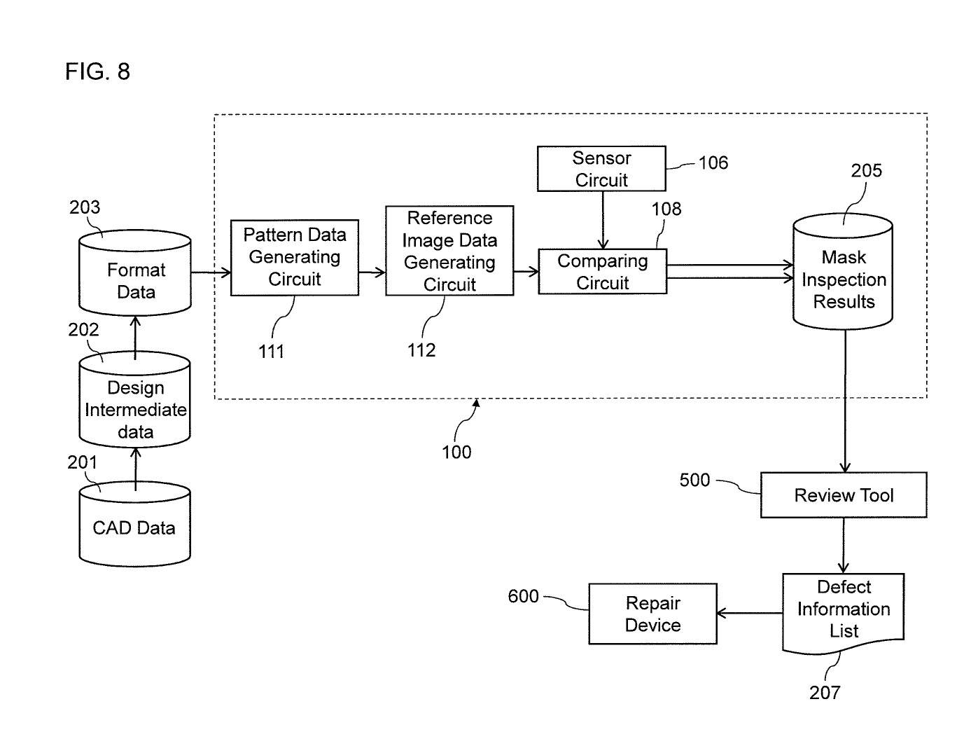

FIG. 8 is a view illustrating a data flow in the second embodiment of the present invention.

As illustrated in FIG. 8, CAD data 201 produced by a designer (user) is converted into design intermediate data 202 having a hierarchical format. The pattern data, which is produced in each layer and formed in the mask 101, is stored in the design intermediate data 202. At this point, generally the inspection apparatus is not configured to directly read design intermediate data 202. That is, independent format data is used by each manufacturer of an inspection apparatus. For this reason, the design intermediate data 202 is input to the inspection apparatus 100 after conversion into format data 203 unique to the inspection apparatus in each layer. In this case, the format data 203 can be set to a data format that is unique to the inspection apparatus 100.

An example of a method for inspecting the mask 101 with the inspection apparatus 100 in FIG. 7 will next be described below. Through the description of an inspection method according to the present embodiment in which the inspection apparatus 100 is used, the functions of the respective elements of the section A and the section B will be described in more detail.

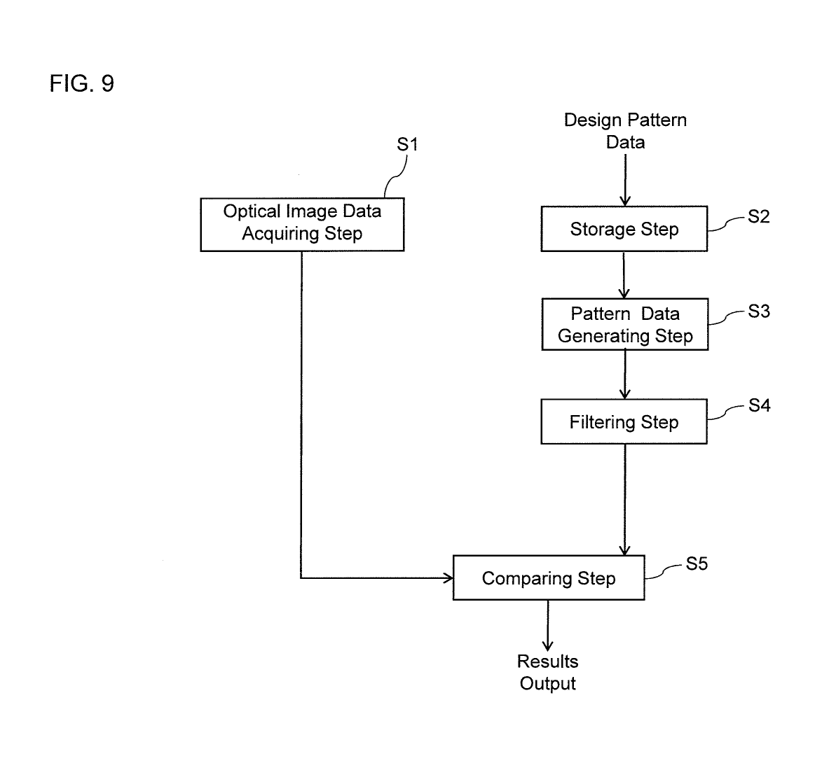

FIG. 9 is a flowchart illustrating the inspection method.

The inspection method by die-to-database comparison method will be described below. Therefore, a reference image data which is compared with an optical image data of the sample to be inspected is a reference image data which is generated based on a design data (design pattern data). In the present embodiment, an inspection apparatus can be adopted to the inspection method by the die-to-die comparison method. In this case, the reference image data becomes an optical image data different from the optical image data of the inspection target.

As shown in FIG. 9, the inspection process includes an optical image data acquiring step (S1), a storage step for design pattern data (S2), a pattern data generating step (S3), a filtering step (S4), a comparing step between an optical image data and a reference image data (S5).

### <Acquiring Step>

In the optical image acquiring step (S1) as shown in FIG. 9, the section A (of FIG. 7) acquires an optical image data (a measurement data) of the mask 101. The optical image data is the image data of the mask 101 on which pattern figures are written based on pattern figure data included in the design pattern data. One example of a process in which an optical image data is acquired will be described using FIGS. 7 and 9.

The mask 101 is mounted on the XYθ-table 102. The XYθ-table 102 is moved in the X direction and the Y direction, which are two horizontal directions orthogonal to each other, respectively, and is rotated about the vertical θ axis. The XYθ-table 102 can be moved in the X and Y directions and rotated in a θ direction by a drive system such as a 3-axis (X-Y-θ) motor driven by the table control circuit 114 under the control of the control computer 110 as shown in FIG. 7. These X-, Y-, and θ-axis motors may be, for example, step motors. The laser measuring system 122 measures the positions of the XYθ-table 102, and the measurement data is sent to the position measuring circuit 107. In the case that the inspection apparatus 100 includes the auto loader 130, the mask 101 on the XYθ-table 102 is automatically loaded from the auto loader 130 driven by the auto-loader control circuit 113, and upon completion of the inspection, the mask 101 is automatically carried out from the XYθ-table 102.

The light source 103 emits the inspection light. The light emitted from the light source 103 transmits through the illumination optical system 170 and is focused on the mask 101 that is the inspection target. The illumination optical system 170, for example, is configured to include lenses such as a condenser lens and mirrors.

As illustrated in FIG. 7, the light, which is emitted from the light source 103 and passes through the mask 101 forms an optical image on the photodiode array 105, transmits the desired lens 6 selected from a plurality of objective lenses 6 included in the objective lens switching mechanism 1 and forms an optical image on the photodiode array 105.

At this time, as described above with reference to FIG. 1, etc., the objective lens 6 of objective lens switching mechanism 1 is one objective lens having performance capability suitable for inspection among the plurality of objective lenses 6 included in the objective lens switching mechanism 1 according to the type or the pattern fineness, etc. of the mask 101 to be inspected. The objective lens 6 is easily switched using the objective lens switching mechanism 1 according to the selection and is safely disposed to the inspection position with high installation position accuracy. Therefore, the inspection apparatus 100 can easily and safely dispose one objective lens 6 having performance capability optimal to the inspection of the mask 101 at the inspection position for inspection with high position accuracy and perform the inspection of the mask 101 by a method to be described below.

The pattern image formed on the photodiode array 105 as shown in FIG. 7 is photoelectrically converted by the photodiode array 105 and A/D (analog to digital) converted by the sensor circuit 106 into an optical image data. An image sensor is arranged in the photodiode array 105. As for the image sensor according to the present embodiment, for example, a CCD (Charge Coupled Devices) type line sensor can be used. The line sensor may be, for example, TDI (Time Delay Integration) sensor. Thus, the pattern in the mask 101 is imaged by the TDI sensor while the XYθ-table 102 is continuously moved in the positive or negative X direction.

The optical image data, which was acquired in the optical image acquiring step (S1), is sent to the comparing circuit 108 as shown in FIG. 7 and FIG. 8.

### <Storage Step>

In FIG. 9, S2 is the storage step. In FIG. 7, the design pattern data that was used to form the pattern in the mask 101 is stored in the magnetic disk 109 serving as a storage.

The designed pattern includes graphic pattern figures each consisting of basic pattern figures such as rectangles and triangles. The magnetic disk 109 stores feature data indicating the shape, size, and position of each pattern feature, specifically, information such as the coordinates (x, y) of the reference position of each feature, the length of its sides, and a shape code (or identifier) identifying the type of shape, such as a rectangle or triangle.

A set of graphic patterns existing within a range of several tens of micrometers is generally called a cluster or a cell, and the data is layered using the cluster or cell. In the cluster or cell, a disposition coordinate and a repetitive amount are defined in the case that various graphic patterns are separately disposed or repetitively disposed with a certain distance between. The cluster or cell data is disposed in a strip-shaped region called a stripe. The strip-shaped region has a width of several hundred micrometers and a length of about 100 mm that corresponds to a total length in an X-direction or a Y-direction of the mask 101.

### <Pattern Data Generating Step>

At the pattern data generating step (S3) in FIG. 9, the pattern data generating circuit 111 as shown in FIG. 7 retrieves design pattern data of the mask 101 from the magnetic disk 109 through the control computer 110 and converts it into 2-bit or other multiple-bit image data (design image data) . This image data is sent to the reference image data generating circuit 112.

After the design pattern data to be the feature data is input to the pattern data generating circuit 111, the pattern data generating circuit 111 generates data of each pattern feature, and interprets the shape code in the data indicative of the shape of the pattern feature and obtains its dimensions. The pattern data generating circuit 111 then divides the pattern into a virtual grid of squares (or grid elements) having predetermined quantization dimensions, and generates 2-bit or other multiple-bit design image data of the design pattern segment in each grid element. By using the generated design image data, the pattern data generating circuit 111 calculates the design pattern occupancy in each grid elements corresponding to a sensor pixel. This pattern occupancy in each pixel represents the pixel value.

### <Filtering Step>

At the filtering step (S4) in FIG. 9, the design image data as an image data of the feature sent to the reference image data generating circuit 112 (of FIG. 7) has appropriate filtering performed thereon.

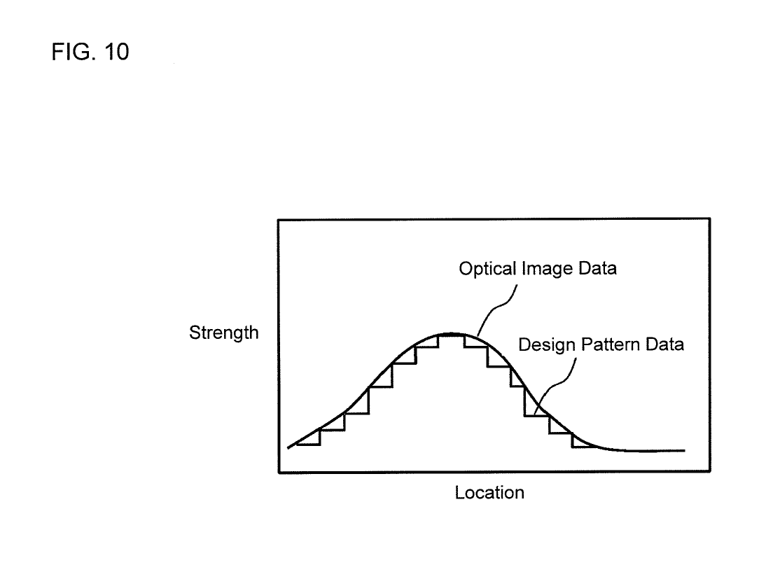

FIG. 10 shows the filtering step.

The measurement data as an optical image data output from the sensor circuit 106 as shown in FIG. 7 is somewhat “blurred” due to the resolution characteristics of the objective lens of the objective lens switching mechanism 1 and due to the aperture effect in the photodiode array 105, that is, this optical image is a spatially low-pass filtered image. Therefore, since the design image data corresponding to the optical image is digital data consisting of digital values representing the intensity (or gray scale) of each point of the image, this design image data may be filtered to match the “blurred” optical image, or measurement data. In this way, a reference image data to be compared with the optical image data is produced.

### <Comparing Step>

S5 as shown in FIG. 9 is the comparing step. As shown in FIG. 7, the optical image data is sent from the sensor circuit 106 to the comparing circuit 108. The design pattern data is converted into reference image data by the pattern data generating circuit 111 and the reference image data generating circuit 112, and is then sent to the comparing circuit 108. The position data output from the position measuring circuit 107 which connects to the laser measuring system 122 and detects the position on the mask 101 of the optical image, is input to the comparing circuit 108.

The comparing circuit 108 compares each portion of the optical image data received from the sensor circuit 106 with the corresponding portion of the reference image data generated by the reference image data generating circuit 112 in accordance with a suitable comparison determination algorithm, and if the difference between these portions exceeds a predetermined value, the comparing circuit 108 determines that the portion of the optical image data is defective. Then the coordinates of that portion, the optical image data, and the reference image data, on which the detection of the defect is based, are stored as a mask inspection result 205 (see FIG. 8) in the magnetic disk 109.

Identification of defects can be performed according to the following two types of methods. One method is directed to identifying defects when there is a difference exceeding a predetermined threshold dimension between a position of the outline of the reference image and a position of the outline of the optical image. The other method is directed to identifying defects when the ratio of the line width of the pattern in the reference image and the line width of the pattern in the optical image exceeds a predetermined threshold. With the latter method, the ratio of the distance between patterns in the reference image and the distance between patterns in the optical image may be used for identification of defects.

The mask inspection result 205 is transmitted to a review tool 500 as illustrated in FIG. 8. A review process is an operation in which the operator determines whether the detected defect will become a practical problem. Specifically, the mask inspection result 205 is sent to a review tool 500, the review is performed by the operator who determines whether the defect found in the inspection can be tolerated. The operator can compare and review the reference image as a basis for the defect judgment with the optical image that includes the defect.

In the review tool 500, an image of the mask 101 in the defect portion is displayed while moving the table on which the mask 101 is mounted to observe the coordinates of the defects one by one. In addition, the determination condition of the defect and the optical image and reference image used as grounds for the determination are displayed side by side on the screen of the computer provided in the review tool 500 in order to make a visual verification at the same time.

Further, in a case where the review tool 500 is provided in the inspection apparatus 100, the image of the mask 101 in the defect portion is displayed using an optical system of the inspection apparatus 100. In addition, the determination condition of the defect, the optical image, and the reference image used as grounds for the determination are simultaneously displayed using the screen of the control computer 110 illustrated in FIG. 7.

The information of a defect determined through the review process is stored in the magnetic disk 109 as shown in FIG. 7. In FIG. 8, when even one defect to be repaired is confirmed in the review tool 500, the mask 101 is sent, with a defect information list 207, to a repair device 600, which is an external device of the inspection apparatus 100. Since the repair method is different according to the type of defect, that is, between the extrusion and intrusion defects, the type of the defect, including determination between the extrusion and intrusion defects and the coordinates of the defect are added to the defect information list 207.

The present invention is not limited to the embodiments described above and can be implemented in various ways without departing from the spirit of the invention.

The above description of the present embodiment has not specified apparatus constructions, control methods, etc. which are not essential to the description of the invention, since any suitable apparatus constructions, control methods, etc. can be employed to implement the invention. Further, the scope of this invention encompasses all objective lens switching mechanisms, inspection methods, and apparatuses employing the elements of the invention and variations thereof, which can be designed by those skilled in the art.

What is claimed is:

1. An objective lens switching mechanism comprising:
a rotating mechanism configured to include a rotating table and a stage disposed on the rotating table;
a plurality of lens mounts disposed around the rotating mechanism;
a plurality of objective lenses respectively disposed on each of the plurality of lens mounts;
a lens holder disposed on the stage of the rotating mechanism and configured to hold each of the plurality of objective lenses; and
a plurality of connecting members, which is attached to the lens holder, configured to respectively connect each of the plurality of objective lenses to the lens holder,
wherein the objective lenses are moved between a first position on the lens mounts and a second position above the lens mounts by an operation of the stage of the rotating mechanism and are moved from the the second position above the lens mounts to another second position above the lens mounts by an operation of the rotating table, so that one selected from the plurality of objective lenses is disposed on the lens mount of a desired position.

2. The objective lens switching mechanism according to claim 1, wherein
the first position is an installation position on the lens mount of the objective lens, and
the second position is a position above the lens mount to an upper side in a vertical direction.

3. The objective lens switching mechanism according to claim 1, wherein
the lens holder includes a support member configured to contact a portion of the objective lens and support the objective lens from a lower side, and
the support member is configured to contact and support the objective lens when the lens holder is moved by the operation of the stage and the objective lens is moved from the first position to the second position.

4. The objective lens switching mechanism according to claim 2, wherein
the lens holder includes a support member configured to contact a portion of the objective lens and support the objective lens from a lower side, and
the support member is configured to contact and support the objective lens when the lens holder is moved by the operation of the stage and the objective lens is moved from the first position to the second position.

5. The objective lens switching mechanism according to claim 1, wherein the connecting member is a spring member that has a flexibility in a direction parallel to an operating direction of the stage and has a stiffness in a direction perpendicular to the operating direction of the stage.

6. The objective lens switching mechanism according to claim 2, wherein the connecting member is a spring member that has a flexibility in a direction parallel to an operating direction of the stage and has a stiffness in a direction perpendicular to the operating direction of the stage.

7. The objective lens switching mechanism according to claim 3, wherein the connecting member is a spring member that has a flexibility in a direction parallel to an operating direction of the stage and has a stiffness in a direction perpendicular to the operating direction of the stage.

8. The objective lens switching mechanism according to claim 4, wherein the connecting member is a spring member that has a flexibility in a direction parallel to an operating direction of the stage and has a stiffness in a direction perpendicular to the operating direction of the stage.

9. The objective lens switching mechanism according to claim 1, wherein the objective lens selected from the plurality of objective lenses is disposed on the lens mount of the desired position which is an inspection position of an inspection apparatus for optically inspecting a sample to be inspected when the objective lens switching mechanism is used as a component of the inspection apparatus.

10. An inspection apparatus comprising:
a light receiving device configured to capture an optical image of a sample to be inspected;
an illumination optical system configured to irradiate the sample with inspection light; and
an objective lens switching mechanism configured to include a plurality of objective lenses, select one of the objective lenses, dispose the selected objective lens at an inspection position, so as to form an image by the light passed through or reflected by the sample on the light receiving device,
wherein the objective lens switching mechanism includes:
a rotating mechanism configured to include a rotating table and a stage disposed on the rotating table;
a plurality of lens mounts disposed around the rotating mechanism;
a plurality of objective lenses respectively disposed on each of the plurality of lens mounts;
a lens holder disposed on the stage of the rotating mechanism and configured to hold each of the plurality of objective lenses; and
a plurality of connecting members, which is attached to the lens holder, configured to respectively connect each of the plurality of objective lenses to the lens holder,
wherein the objective lenses are moved between a first position on the lens mounts and a second position above the lens mounts by an operation of the stage of the rotating mechanism and are moved from the the second position above the lens mounts to another second position above another lens mounts_by an operation of the rotating table, so that one selected from the plurality of objective lenses is disposed on the lens mount of a desired position which is the inspection position.

11. The inspection apparatus according to claim 9, wherein the connecting member of the objective lens switching mechanism is a spring member that has a flexibility in a direction parallel to an operating direction of the stage and has a stiffness in a direction perpendicular to the operating direction of the stage.
